(19) United States
(12) Patent Application Publication
(10) Pub. No.: US 2011/0208671 A1
(43) Pub. Date: Aug. 25, 2011

(54) INVESTMENT SYSTEM AND METHOD

(75) Inventor: Shane Edwards, Central (HK)

(73) Assignee: THE ROYAL BANK OF SCOTLAND PLC, Edinburgh (GB)

(21) Appl. No.: 12/962,119

(22) Filed: Dec. 7, 2010

(30) Foreign Application Priority Data
Dec. 8, 2009 (AU) 2009245855

(51) Int. Cl. G06Q 40/00

(52) U.S. Cl. 705/36 R

(57) ABSTRACT

A computer implemented investment method comprises: financing an investor with a limited-recourse loan to make an investment in a security, the investment having an underlying investment strategy, which is to be applied over a plurality of investment periods, and periodic investment exit points; for each period of the investment, calculating a payment, which is payable by the investor in order to remain invested in the investment; investing during each period according the underlying investment strategy; calculating: a first redemption value if the investor exits at an exit point before the end of a final period, the value at least in part determined by the performance of the investment up to the point of exit; or a second redemption value if the investor remains invested over all periods, the value at least in part determined by the performance of the investment up to the end of the final period; and determining a redemption payment to the investor according to the respective redemption value and the loan amount.

### FIELD OF THE INVENTION

The present invention relates to financial investment systems and methods.

### BACKGROUND TO THE INVENTION

It is well known that investors (people or organisations) can invest in various markets around the world. Markets may be financial markets, equity markets, commodity markets or derivative markets, for example. While investors can themselves invest directly in some markets, it is often the case that cost and volume requirements in other markets are beyond most investors. Indeed, some investors do not wish to take on the responsibility for actively managing such investments. Accordingly, it is common for investors to invest indirectly in markets, via a managed investment fund, which exposes the investor(s) to the markets. A fund manager, which manages the investments of the fund, typically uses an aggregated investment from many investors to invest in the fund. The fund may be configured as an investment trust, and investments may then be in the form of buying units in the fund.

So-called structured products are also known, which are offered as investments by some fund managers and/or financial institutions. The US Securities and Exchange Commission defines a structured product as “securities whose cash flow characteristics depend upon one or more indices or that have embedded forwards or options or securities where an investor's investment return and the issuer's payment obligations are contingent on, or highly sensitive to, changes in the value of underlying assets, indices, interest rates or cash flows.”. In general, a structured product has a set of predetermined investment rules, which can be referred to as an underlying investment strategy, and typically include defined durations and other attributes, which dictate how the associated investment is made, and for how long, in response to changes in the value of underlying assets, indices, interest rates or cash flows. The underlying investment strategy may itself be thought of as an ‘index’, insofar as returns produced by it can be tracked, plotted and predicted (and/or hedged), and investments therein are typically made, and returns paid, depending on the performance and variation thereof over time. Put another way, a structured product is a half-way-house between a static index product and a discretionary managed fund, in that the investment strategy is dynamic (like a discretionary managed fund) but has a strict underlying investment strategy (like a traditional tracker index fund but typically more complex), which controls how the active investment is performed.

Structured products are perceived to have various advantages, including diversification, professional management and economies of scale (through aggregation), for example. An advantageous feature of some known structured products is the ability to tailor the investment strategy to particular risk and return objectives: even on a per investor basis. Another advantageous feature is the ability to guarantee a return or even afford capital protection, whereby, as a worst case scenario, at the maturity of the investment, a minimum of an investor's initial capital investment is returned. However, an investor typically has to remain invested in such a product until maturity, irrespective of product performance during the term. In addition, some structured products may still be beyond many investors.

It is desirable to provide new and more efficient ways to provide access to, and operation of, various kinds of investments.

### SUMMARY OF THE INVENTION

According to a first aspect, the present invention provides: a computer implemented investment method, comprising: financing an investor with a limited-recourse loan to make an investment in a security, the investment having an underlying investment strategy, which is to be applied over a plurality of investment periods, and periodic investment exit points; b. for each period of the investment, calculating a payment, which is payable by the investor in order to remain invested in the investment; c. investing during each period according the underlying investment strategy; d. calculating: a first redemption value if the investor exits at an exit point before the end of a final period, the value at least in part determined by the performance of the investment up to the point of exit; or a second redemption value if the investor remains invested over all periods, the value at least in part determined by the performance of the investment up to the end of the final period; and e. determining a redemption payment to the investor according to the respective redemption value and the loan amount.

According to a second aspect, the present invention provides an automated investment system, comprising: a processor programmed to perform an underlying investment strategy over a plurality of investment periods, the processor being responsive, with respect to an investment amount of each of a plurality of investors, to make investments according to the underlying investment strategy based on signals indicating a level of investment, market conditions and receipt of a payment from the investor for an investment period.

### BRIEF DESCRIPTION OF THE DRAWINGS

Various features and advantages of the invention will become apparent from the following description of embodiments of the invention, given by way of example only, which is made with reference to the accompanying drawings, of which:

FIG. 1 is a functional block diagram of a computerised investment system according to an embodiment of the invention;

FIG. 2 is a flow diagram illustrating the steps involved in investing and trading pursuant to an investment strategy, operated by the system in FIG. 1, according to an embodiment of the invention;

FIG. 3 is a flow diagram illustrating the steps undertaken as between an investing institution and an investor, operated by the system in FIG. 1, according to an embodiment of the invention;

FIG. 4 is a graph illustrating an exemplary performance of an underlying investment strategy performed by the system of FIG. 1; and

FIG. 5 is a block diagram of an exemplary computer system that is able to implement an investment system according to an embodiment of the present invention.

### DETAILED DESCRIPTION OF AN EMBODIMENT OF THE INVENTION

Various embodiments of the present invention will now be described in more detail with reference to the accompanying drawings. It will be appreciated that the invention is not limited in its application to the details of method and the arrangement of components as set forth in the following description or illustrated in the drawings. It will be apparent to a person skilled in the art that additional embodiments of the present invention not detailed in the description are possible and will fall within the scope of the present claims. Accordingly, the following description should not be interpreted as limiting in any way, and the scope of protection is defined solely by the claims appended hereto.

In general terms embodiments of the present invention relate to an automated investment system, and to a method of operating it according to an underlying investment strategy.

According to embodiments of the present invention, the underlying investment strategy is a volatility stabilised investment strategy. In basic terms, a volatility stabilised investment strategy aims to produce a relatively more stable level of volatility for an underlying investment. Such techniques typically involve systems which allocate more exposure to an underlying investment during times when it is less volatile and allocate less exposure to an underlying investment during times when it is more volatile, thereby seeking to produce an investment volatility profile which is less variant to external circumstances than an investment would be that did not have volatility stabilisation techniques applied to it. Volatility stabilised investment strategies as such are known and a detailed description thereof is beyond the scope of the present description. Further information on volatility can be found in various standard text books, such as “Options, Futures and Other Derivatives”, 7^{th} Edition, John C. Hull.

The system is arranged to invest in a security (the “investment”). The term “security” generally represents an entitlement to a financial asset and can include, without limitation, any one or more of debt securities, such as banknotes, bonds and debentures, equity securities such as common stocks, derivative contracts, such as forwards, futures, options, warrants and swaps and/or units in collective investment schemes, including funds and trusts. As used herein, the term security also represents an investment comprising any one or more of the preceding (or other) kinds of instrument.

In addition to the underlying investment strategy, the system has a dependence upon whether an investor has made up-to-date periodic payments, which are typically calculated as interest payments on a loan, which the investor was previously required to enter into to finance the investment as part of investment initiation. In essence, the investment is inextricably linked to the finance arrangement. The payments may be interest payments only, or interest payments with additional amounts, for example, to cover payment protection or the like. Alternatively, the payments may be calculated and/or determined in another appropriate way; but will still equate to a small fraction of the loan amount and will thus be referred to herein as loan interest payments or equivalent, unless the contrary is indicated. According to embodiments of the invention, the loan provider granting the loan does so on the condition the loan is used to purchase a financial security, which the loan provider has stated is the purpose of the loan. The loan typically equates to 100% of the investment capital; though it could be for a greater or lesser amount.

According to an embodiment of the invention, the finance is in the form of a limited-recourse loan, which is arranged as part of investment initiation. The underlying investment strategy comprises a plurality of investment periods, and investors are provided with an opportunity to exit the investment at the end of each investment period, or remain invested in the investment until a maturity date of the investment (i.e. the end of the final investment period). Interest is payable by the investor in respect of each period during which the investor remains invested.

According to an embodiment of the invention the loan is ‘limited recourse’ insofar as it can be repaid at par, without penalty at the end of each investment period, or at maturity, and the investor will not be liable to repay the whole (or even a part) of the loan, other than as a deduction from any investment returns that are due on exit. In practice, a redemption value may be calculated on exit or maturity, including by factoring in the loan amount and the investment performance up to the respective point in time.

In tying embodiments of the present invention to a requirement to finance the investment using a loan from a loan provider which specifies the stated investment purpose of the loan, the present inventors have appreciated problems that investors may face in obtaining investment loans which stem from problems that loan providers face in granting such loans.

From the loan provider's perspective, granting unsecured loans entails a substantial counterparty risk of the borrower and burdens the borrower with the liability of having to repay the loan, the conditions of which typically stipulate full recourse to the borrower's entire assets. Providing collateral, in the form of a pledged financial security mitigates the risk of borrower default to the loan provider, but does not completely eliminate such risk as the market value of the financial security pledged as collateral may decline or itself become worthless due to, for example, insolvency of the issuer of the financial security. However, where the loan provider is able to specify the strict purpose of the loan for investment into a prescribed financial security, the loan provider is then able to ensure the quality of collateral securing the loan and thus provide limited recourse or no-recourse lending on the basis of the collateral providing an acceptable level of security without further recourse to the borrower's other assets being required.

According to embodiments of the invention, the loan provider and the issuer of the financial security may be closely related entities (such as wholly or partly owned subsidiary companies). Alternatively, the issuer of the specified financial security (e.g. a unit in a trust) may be the manager of a collective investment scheme, which, on behalf of investors, will purchase a prescribed financial security issued by the loan provider or one of its associates. Many other arrangements of loan provider and issuer, with zero or more intermediary parties, are anticipated and accommodated within the scope of embodiments of the present invention.

Particularly in embodiments in which the loan provider and security issuer are closely related (or at least are working in concert), the risk of providing a limited recourse (or no recourse) loan to an investor is minimal, and there is zero credit risk in respect of the investor who is notionally receiving the loan. This is because the loan provider, in effect (and insofar as the loan is notional and money does not physically pass to the investor) makes the loan to itself; whereby the concept of defaulting on the loan is entirely avoided (i.e. in principle you cannot default on a loan to yourself). By way of a simple example of how the investment might work, in order to guarantee that the loan amount is protected, so that 100% of the loaned amount can be returned at any future exit point, part of the investment can be placed into a fixed interest deposit account to ensure that the original sum is available at the exit point. For example, if the investor notionally borrows and invests 100 (the units of which are immaterial), and can exit at multiples of twelve months after investment, 100/1.05=95.24 of the investment can be placed in a 5% pa interest bearing deposit account, to ensure growth back to 100 after twelve months, and the remainder of the investment, 100−95.24=4.76, can be invested in an option, for example, that pays: notional*Max(0, upside performance of an investment strategy). At the end of each year, the investment return from the option, if any, plus 4.76 deducted from the deposit account (which can be invested in the deposit account again to re-grow to 100 over the next twelve month period), can be invested again; and so on each year. In addition, any interest payment payable by the investor on the loan in respect of each period may also be used to fund the investment. Alternatively, if the investor exits, the protected 100 is repaid and a proportion of the investment return accrued up to the exit date may be paid to the investor. Of course, there are many alternative ways of protecting investments (according to various risk/certainty profiles), and generating returns, that could be applied according to embodiments of the invention.

The way a redemption value on exit is calculated may vary depending on various factors and, in particular, on whether the redemption is an early exit or at maturity. In any event, according to an embodiment to be described, the redemption figure has a pre-agreed floor, which may be zero, such that there would be no requirement for a balancing payment from the investor, to cover the loan amount, even if the security's performance is very poor. In other embodiments of the invention, there may be some recourse requiring repayment of at least a part of the loan if there is a shortfall in the investment performance.

The aforementioned financing arrangement is particularly beneficial and provides a high degree of leverage—insofar as only a small percentage of the investment amount (i.e. effectively via interest payments) is actually paid by the investor—with the main investment capital being provided by a limited recourse loan.

The investment may be structured as a unit trust, whereby an investor invests by buying units, and the funds are used, for example, for investment by a fund manager according to an underlying investment strategy, which may be a structured product. Redemption and settlement at an exit point or at maturity may then involve paying a return which is a function of increased unit price. Top-up payments, bonus payments, guaranteed minimum payments or other financial incentives may be employed and become payable if an investor remains invested for the full term of the investment. Such payments may be less, or not payable at all, in the event of early exit. In addition, coupons may be payable periodically during the term of the investment. The coupons may be guaranteed or contingent and they may be at a fixed interest rate or vary depending on, for example, time invested or other performance and/or other prevailing conditions.

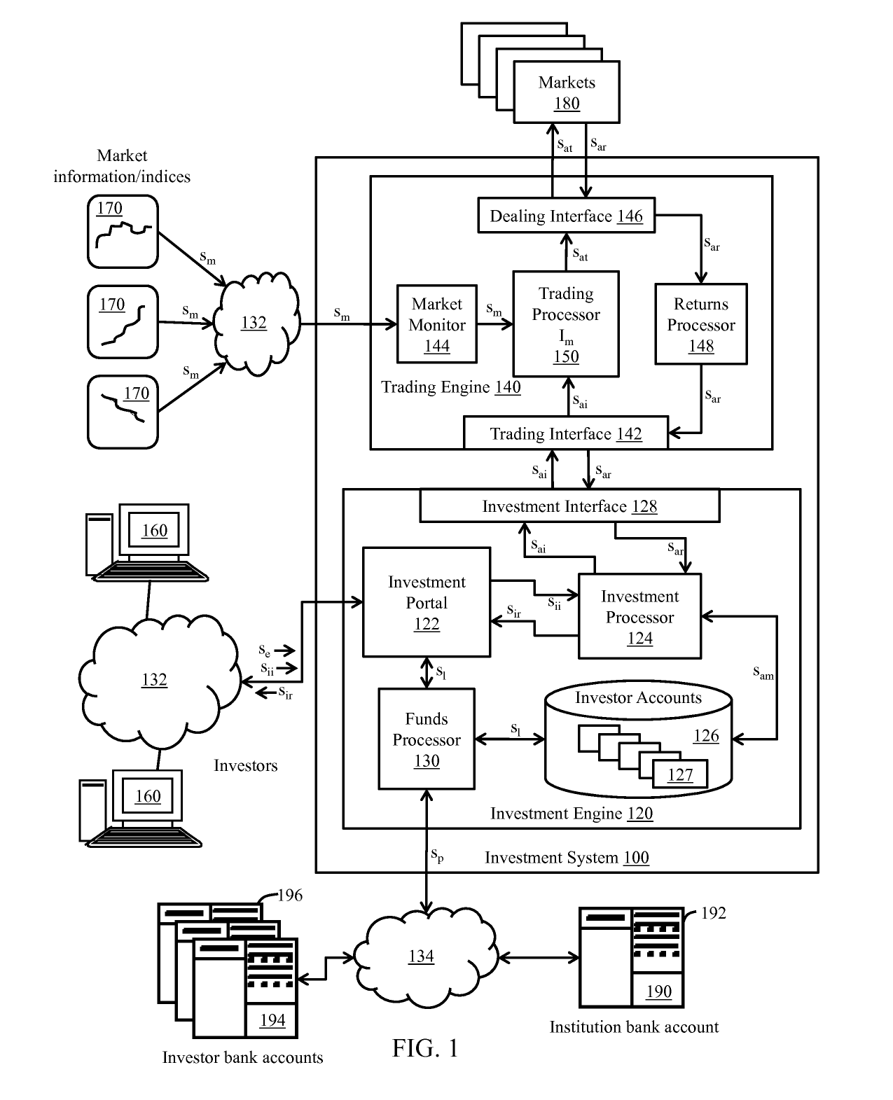

A computerised investment system according to an embodiment of the present invention is illustrated in the functional block diagram in FIG. 1. The system 100 comprises an investment engine 120 and a trading engine 140. The investment engine 120 is generally responsible for receiving investment instruction signals sᵢᵢ from a plurality of individual investors 160, presenting aggregated investment instruction signals sₐᵢ to the trading engine 140, and returning individual returns signals sᵢᵣ to the individual investors in response to aggregated returns information signals sₐᵣ from the trading engine 140. The trading engine 140 is generally responsible for investing the aggregated investments in one or more markets 180 in response to market information signals sₘ received from respective market information sources 170.

The investment engine 120 comprises an investment portal 122, an investment processor 124, an investor accounts database 126, an investment interface 128 and a funds processor 130. The investment portal 128 presents, via the Internet 132, a web interface to investors 160, who are registered with an investment service provider that provides access to the investment system 100.

The investment portal 122 typically comprises a secure web server application, which provides secure transaction capabilities, by which an investor can enter into and control respective investment contracts, according to pre-determined constraints, by issuing individual investment instruction signals sᵢᵢ. Dedicated, secure communications links (not shown) may be used instead of the Internet.

Individual investor account records 127 are stored in the investor accounts database 126 and accounts are managed and updated by the investment processor 124, for example in response to investment instruction signals sᵢᵢ from investors and aggregated returns information signals sₐᵣ from the trading engine 140. Periodically, the investment processor 124 is required to read individual investor account records 127 in the investment accounts database 127 and present aggregated investment instruction signals sₐᵢ to the trading engine 140 via the investment interface 128.

The term ‘aggregated’ is used herein to indicate that the instructions relate to investments and returns associated with plural investors. In effect, investments of the same kind from plural individual investors are aggregated by the investment processor 124 into instructions for one or more larger investments to be made by the trading engine 140. In this manner, individual investors can gain exposure to certain underlying investments, such as structured products, that they would not otherwise have the buying power to invest in.

The trading engine 140 comprises a trading interface 142 for receiving aggregated investment instruction signals sₐ, from the investment engine 120 and for delivering aggregated returns information signals sₐᵣ to the investment engine 120.

The trading engine 140 further comprises a market monitor 144, a dealing interface 146, a returns processor 148 and a trading processor 150. The market monitor 144 is in communication, for example via the Internet 132, with one or more market information sources 170, which generate market indicator signals sₘ relating to market performance and conditions in one or more markets. The market monitor 144 receives the market indicator signals sₘ and passes them to the trading processor 150, which uses the signals to determine which trades to enter into according to its underlying investment strategy, Iₘ. The dealing interface 146 is connected, via the Internet or other appropriate secure communications links, with one or more market exchanges 180, which execute trades on the basis of aggregated trading instruction signals sₐₜ received from the investment system 100. It will be appreciated that the market monitor 144 may elicit information directly from the various exchanges 180 instead of, or in addition to, other appropriate sources.

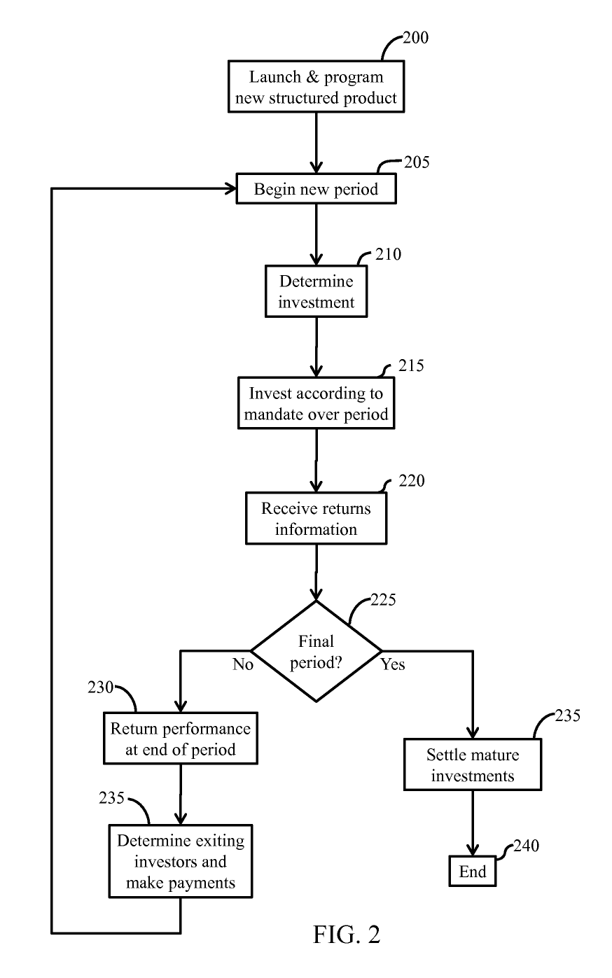

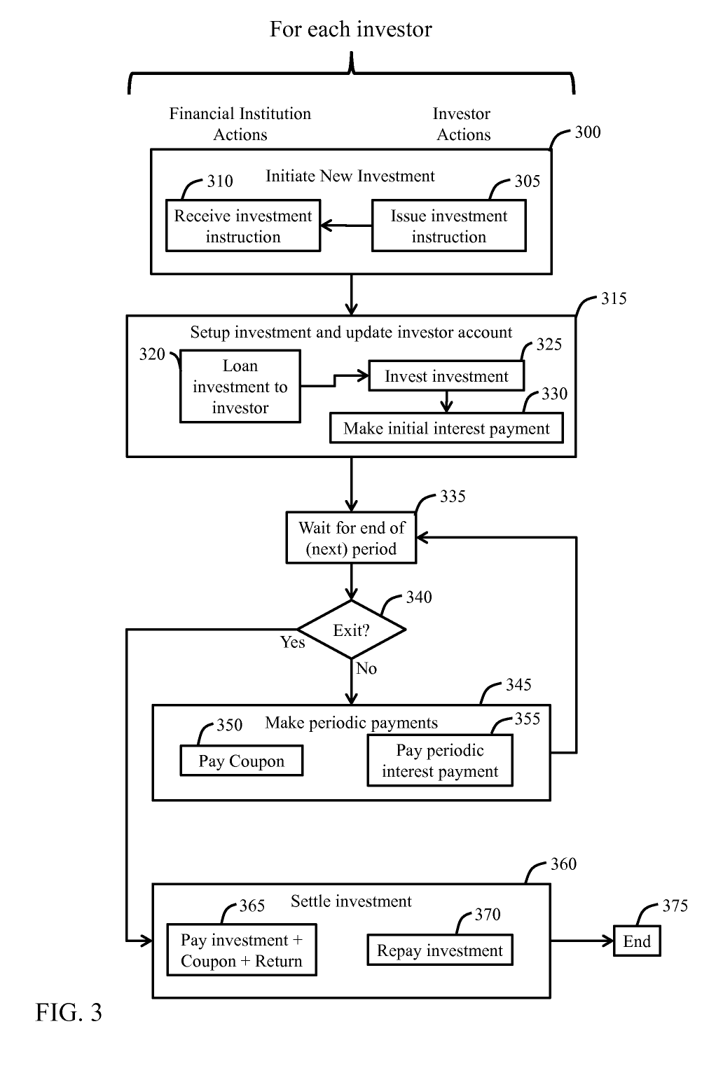

The operation of an embodiment of the present invention employing the system of FIG. 1 will now be described with reference to the flow diagrams in FIG. 2 and FIG. 3.

The flow diagram in FIG. 2 illustrates steps that are generally associated with trading and returns aspects of the investment system 100, with information flowing to and from the investment engine 120 and the information sources 170, according to an embodiment of the present invention.

First [step 200], a new structured product is launched and the underlying investment strategy is programmed into the investment processor 124 and the trading processor 150. According to the present embodiment, the structured product is arranged to be invested over a number of fixed periods. In alternative embodiments, the number of periods could be open-ended. Next [step 205], the first investment period starts: each period, for example, may be measured in days, weeks, months or years. According to the present embodiment, each investment period is one year.

The investment processor 124 determines the level of the investment available [step 210], and communicates respective aggregated investment signals sₐᵢ to the trading processor 150 via the investment interface 128. The level is determined according to an investment amount aggregated over the plural investor accounts 127 of investors who are participating in the investment: if the period is the first period then the level is purely the investment by the investors (subject to any management fees etc.); if the period is a subsequent period then the level includes, in addition, accrued capital (after payment of any one or more of tax, returns, fees and commissions etc.) remaining after previous periods. Next [step 215], the trading engine 150 performs the investment, via the dealing interface 146, according to the underlying investment strategy; based on the aggregated investment signals sₐᵢ and market information signals sₘ. Exemplary underlying investment strategies are described in further detail below.

The returns processor 148 receives aggregated returns signals sₐᵣ, via the dealing interface 146, from the markets 180, and respective returns information is passed to the investment processor 124, to be used for updating the individual investor accounts 127 [step 220], via appropriate account management signals Sₐₘ.

The subsequent behaviour of the process depends on whether the period that has just ended is the final period or not.

If the period is not the final period [step 225], the individual returns information is returned to the individual investors via investor returns signals sᵢᵣ [step 230]. Publication of overall performance including returns can occur in addition, or alternatively, at any time, for example, hourly, daily, weekly or monthly.

According to the present embodiment, investors are provided with an opportunity to exit the investment after each investment period, without incurring a penalty. Thus, according to the present embodiment, in response to the returns performance information (or, indeed, for any other reason), investors may choose to exit the investment (as will be described in more detail with reference to FIG. 3), by issuing respective exit instruction signals, sₑ, or continue with the investment. In addition, according to some variants, new investors may be provided with an opportunity to begin investing (if late-corners are permitted by the structured product). The investment processor 124 is arranged to determine the number (if any) of investors that wish to exit (and optionally join) the investment, and calculate payments for continuing and exiting investors [step 235].

According to the present embodiment, the underlying investment strategy of the structured product pays a contingent coupon at the end of each period (though coupon payment may not be accommodated by other structured products and other embodiments). Therefore, according to the present embodiment, the investment processor determines a first value to be paid in coupons, for investors wishing to continue with the investment, and a second value to be paid in redemptions, to investors wishing to exit the investment.

The respective first and second values are used to update individual investor accounts 127 via appropriate account management signals sₐₘ. Actual payments are made, in response to payment signals sₚ from the funds processor 130, from a financial institution bank account 190 in a first bank account system 192 to respective investor accounts 194 in one or more other bank account systems 196. The various bank account systems communicate via a secure inter-bank communications network 134. Alternatively, the various accounts (or at least some of them) may be managed within the same physical bank account system.

The process then iterates to the start of a new period 205.

If, on the other hand, the period that has just ended was the final period [step 225], then the investment processor 124 calculates the final redemption values for the remaining investors, the investor accounts are updated accordingly with the respective settlements and the respective payments are made from the financial institution bank account 190 to respective investor accounts 194 in response to respective payment signals sₚ from the funds processor 130.

The flow diagram in FIG. 3 represents the activities of the investment engine 120 with respect to a single investor. It will be appreciated that the same (or similar) steps are carried out for all other investors.

First [step 300], a new investment is initiated, typically via the investor portal 122. This typically involves the new investor 160 issuing an investment instruction signal sᵢᵢ [step 305] to invest in a structured product at the beginning of the first period. If the investor does not start investing in the first period, for some investments, there may be an option to start investing at the beginning of a later period; though, for the present purposes, there is no such option.

The investment engine 120 receives the investment instruction signal sᵢᵢ [step 310]. Next [step 315], the investment is set up for the investor, by creating an investor account 127 and updating it with the particulars of the intended investment.

The financing is managed by the funds processor 130, which sets up the loan to be used as the investment [step 320] in the structured product. Various paper forms and contracts may need to be manually completed and/or executed in addition, in order to satisfy local laws etc. In the present embodiment, the loan is for 100% of the required investment amount. In other embodiments, the loan may be for more or less than 100% of the investment, for example, if additional arrangement fees are due (and are lumped in with the loan) or if less than the entire loan is required. However, as will become apparent, there are advantages in taking a 100% loan, such that the investor's capital can be used elsewhere, for example, for other investments.

The investor invests the investment into the structured product [step 325] (in practice, the funds typically do not pass to the investor: they go straight from the loan provider into the investment as part of the loan arrangement. The funds processor 130 updates the respective investor account details 127 using respective loan signals sₗ. In addition, then, or soon after, the investor makes an initial interest payment for the loan [step 330], based on a pre-determined interest rate structure: for example, the interest rate might be fixed for the life of the structured product, or it may vary depending on various influencing factors, such as investment performance, inter-bank lending rates, retail price indices or the like. If the interest payment is not made on time, the effect is that the loan is cancelled, the investment for that investor is redeemed and the investor does not take any further part in the investment. The interest payment is typically made by the investor from their bank account 194 to the financial institution bank account 190. The interest payment may be triggered by an appropriate signal from the funds processor 130, or by an independent instruction from the investor to a nominated bank. In either case, the funds processor 130 updates the respective investor account 127 in the investor accounts database 126 to reflect that the interest payment has been made. In effect, the investment system 100 is responsive to receipt of information or an appropriate signal to indicate that the interest payment has been made.

Assuming that the interest payment has been made, the investment initiation, from the perspective of the investor, has now been completed.

Hereafter, as illustrated in FIG. 2, the trading engine 140 performs the investment according to the underlying investment strategy Iₘ for a first period [step 215]. The investment engine 120 waits for the end of the period [step 335]. At the end of the period, with knowledge of the performance of the investment, investors are given an opportunity to exit the investment [step 340].

According to the present embodiment, if an investor exits the investment, a redemption may, for example, be calculated [step 360] based on:

Redemption=Investment+Coupon+Return,

where

Coupon=Investment*Max[Coupon Floor, Min[Coupon Cap, Index Perf]],

and

Return=Investment*Max[Floor, Index Perf_{cum}],

and where
‘Index Perf’ is [index level at the end of the relevant period divided by the index level at inception]−1,
‘Index Perf_{cum}’ is the cumulative index performance that accounts for all coupon payments over the period, as will be described,
‘Cap’ is an agreed level at inception, whereby in calculating the Coupon, the Investment is multiplied by the lower (Min) of the Cap or the Index Perf; the Cap value may be influenced by factors such as whether the investment is designed to be income bearing and pay Coupons or focused on capital growth as part of a final redemption
‘Floor’ is an agreed level at inception, whereby in calculating the Return, the Investment is multiplied by the higher (Max) of the Floor and the Index Perf_{cum},

Additionally, the investor repays the investment loan [step 370] (in this example, the loan repayment is factored into the redemption).

In other words, according to the present embodiment, there is no penalty as such for exiting the investment—because the investment is effectively returned at par (i.e. in full) so that the loan can be repaid in full, the coupon is still paid—and there is an opportunity for a return based on investment performance to date.

The process then ends for that investor [step 375] for the respective investment.

Of course, there may be a bonus of some kind or a guaranteed minimum repayment for those who see the investment for its full term through to maturity, and an investor who exits early may miss out on such an additional benefit. However, this is not perceived to be a penalty: rather, it is a missed opportunity or missed bonus.

In the alternative, if an investor wishes to remain invested in the structured product for the next period, the investment engine pays the coupon [step 350] and the investor pays the next interest payment on the investment [step 355] (although, in practice, the two amounts may be netted and then only one party has to pay a respective balancing payment). In response to a signal that the interest payment has been made on time, the process then iterates to initiate the next round of investment, by the investment engine 140, over the next period (as illustrated in FIG. 2).

Of course, if the end of the period [step 335] is the end of the final period, as determined in FIG. 2, then the next step must be settlement by final redemption [steps 235 and 360], and there is no iteration.

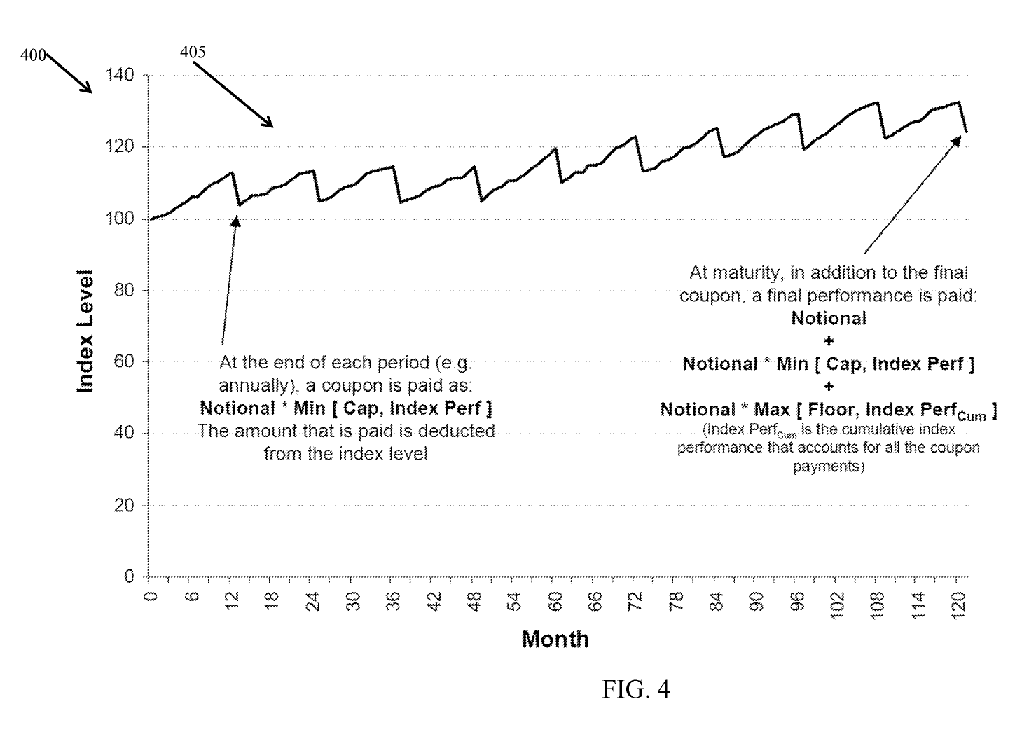

The graph in FIG. 4 illustrates an exemplary performance curve 400, for an investment made by one investor using the system described above. The x-axis of the graph is time in months; the y-axis of the graph is index level. The scale of the y-axis is unimportant for the purposes of this explanation. As shown, the curve 405 demonstrates that an effectively investment tracks an index, which is the result of investing funds according to the underlying investment strategy Iₘ. At the end of each investment period, which is one year in this example, a contingent coupon is paid according to:

Coupon=Investment*Min[Cap, Index Perf]

and the amount of the coupon is deducted from the capital value of the investment (also deducted may be any one or more of tax, fees and commissions etc.). At the maturity of the investment, which is shown in this example as ten years, a redemption is made, according to:

Redemption=Investment+Coupon+Return

where the investment, coupon and return values are calculated as explained above.

Embodiments of the invention may be employed with various kinds of structured products or other investment strategies, for example absolute-return investments.

The underlying investment strategy and therefore the Returns generated from the investment emanate from an investment strategy, which may vary for different embodiments of the invention. Investment strategies may include, but are not limited to, customised investment strategies, customised investment strategies designed by external parties and licensed/approved for use, use of external funds including mutual funds, hedge funds and exchange traded funds as well as strategies referencing various external indices, including various benchmark indices. Investment strategies may comprise of any asset class, including, but not limited to, equities, currencies, commodities, bonds etc. and combinations thereof. Investment strategies may include strategies designed to perform in a variety of different market conditions including market neutral strategies in addition to more typical strategies, like investing in equities, where positive returns are highly dependent on the market environment. Investment strategies may incorporate rule based or discretionary features which change allocation of the underlying investment exposure throughout the term of the investment, for example modifying return exposure from being ‘long’ to being ‘short’ or switching asset class exposure from referencing equities to referencing bonds, for example. According to some advantageous embodiments of the invention, investment strategies are volatility stabilised, as being the implementation of a technique designed to stabilise the volatility of an underlying investment strategy and therefore reduce the impact of external circumstances on the volatility of an underlying investment.

Some examples of calculating redemption values will now be described by way of example only, first for investments maintained for the full term and then for investments having an early exit.

### Full Term Investment

Set out in the table below are some assumed values for one unit in an underlying investment strategy value over an investment term of ten years for three different scenarios. In Scenario 1, the underlying investment strategy value steadily climbs throughout the investment term and pays out regular coupon amounts every year. In Scenario 2, the underlying investment strategy value falls below the starting level by the end of the investment term but paid out regular coupon amounts every year. In Scenario 3, the underlying investment strategy value falls below the starting level by the end of the investment term and paid out no coupon amounts throughout the investment term. A net redemption amount is in addition to any coupon amounts received to in relation to the investment.

| | Underlying Investment | | |
|---|---|---|---|
| | Strategy Value | | |
| Date | Scenario 1 | Scenario 2 | Scenario 3 |
| Unit Issue Date | 1.00 | 1.00 | 1.00 |
| Coupon amounts paid throughout the | $0.45 | $0.45 | 0 |
| investment term | | | |
| Value at maturity date (Valuation | 2.10 | 0.90 | 0.85 |
| Date) | | | |

The Net Redemption Amount of the Units is calculated in accordance with the following formula:

Net Redemption Amount=Max(0, Participated Growth, Catch-up Level)

where:
Participated Growth=Participation rate (Year 10)*[Underlying Investment Strategy Value (Year 10)−Loan Amount]
Underlying investment Strategy Value (Year 10) is the closing value of the Underlying Investment Strategy on a final Valuation Date
Catch-Up Level=Guaranteed Investment Return−Sum [Contingent Coupons (Year 1 to Year 10 inclusive)]−Loan Amount.

### Scenario 1

Based on the values set out in the table above, the Net Redemption Amount per Unit of investment at Maturity for Scenario 1 would be:

$$\begin{matrix}Net Redemption Amount = Max ( \begin{matrix}0 , 200 \% * ( 2.10 - 1.00 ) , \\ ( \$1 .50 - \$0 .45 - \$1 .00 )\end{matrix} \\ = Max ( 0 , 2.20 , 0.05 ) \\ = \$2 .20\end{matrix}$$

For a holding of 25,000 Units, this would be $55,000

### Scenario 2

Based on the values set out in the table above, the Net Redemption Amount per Unit at Maturity for Scenario 2 would be:

$$\begin{matrix}Net Redemption Amount = Max ( \begin{matrix}0 , 200 \% * [ 0.90 - 1.00 ] , \\ ( \$1 .50 - \$0 .45 - \$1 .00 )\end{matrix} \\ = Max ( 0 , - 0.20 , 0.05 ) \\ = \$0 .05\end{matrix}$$

For a holding of 25,000 Units, this would be $1,250

### Scenario 3

Based on the values set out in the table above, the Net Redemption Amount per Unit at Maturity for Scenario 3 would be:

$$\begin{matrix}Net Redemption Amount = Max ( \begin{matrix}0 , 200 \% * [ 0.85 - 1.00 ] , \\ ( \$1 .50 - \$0 - \$1 .00 )\end{matrix} \\ = Max ( 0 , - 0.30 , 0.50 ) \\ = \$0 .50\end{matrix}$$

For a holding of 25,000 Units, this would be $12,500

### Early Exited Investment

Set out in the table below are some assumed values of one unit for an underlying investment strategy value at the end of Year 5 for two different scenarios. In Scenario 1, the underlying investment strategy value steadily climbs throughout the Investment Term. In Scenario 2, the underlying investment strategy value falls below the starting level by the end of the investment. The net redemption amount is in addition to any coupon amounts you may have received to date in relation to the investment. Note that the guaranteed investment return does not apply if the investment is redeemed prior to the maturity date.

Underlying Investment
Strategy Value

| Date | Scenario 1 | Scenario 2 |
|---|---|---|
| Unit Issue Date | 1.00 | 1.00 |
| Redemption Date (Year 5) | 1.50 | 0.90 |

The following examples show how the net redemption amount of the investment at the redemption date in Year 5 are calculated, based on the assumed underlying investment strategy values set out in the table above.

The Net Redemption Amount of the Units is calculated in accordance with the following formula:

Net Redemption Amount=Max[0, Participation Rate (Y)*(Underlying Investment Strategy Value (Y)−Loan Amount)]

where:
Underlying investment Strategy Value (Year 5) is the closing value of the Underlying Investment Strategy on the Valuation Date (Year 5), where the Valuation Date for an early exit may coincide with the interest payment date for the following year.

### Scenario 1

Based on the values set out in the table above, the Net Redemption Amount per Unit at Maturity for Scenario 1 would be:

Net Redemption Amount=Max[0,100%*(1.50−1.00)]

=$0.50

For a holding of 25,000 Units, this would be $12,500

### Scenario 2

Based on the values set out in the table above, the Net Redemption Amount per Unit at Maturity for Scenario 2 would be:

Net Redemption Amount=Max[0,100%*(0.90−1.00)]

=$0.00

There would be no Net Redemption Amount under this scenario and there would be no repayment as the loan amount is non-recoverable. This exemplifies the nature of the limited recourse loan.

### Participation Rate

According to the present embodiment, the Net Redemption Amounts, as calculated above, depend on a so-called Participation Rate applicable on the redemption date.

The Participation Rate affects the level of exposure to the underlying investment strategy on the redemption date.

The Participation Rate is variable over the Investment Term. Over the first 4 years, the Participation Rate is less than 100% which means that if the investment is exited (i.e. the loan is terminated) there will be less than 100% exposure to the underlying investment strategy on the redemption date.

From years 6 to 10, the Participation Rate is greater than 100% which means there will be more than 100% exposure to the underlying investment strategy on the redemption date.

The Participation Rates and associated dates illustrated in the table below are by way of example only and different values may be applied.

| | Interest | Redemption | Participation |
|---|---|---|---|
| Year | Payment Date | Date | Rate |
| 0 | 20-Jun.-2010 | N/A | N/A |
| 1 | 20-Jun.-2011 | 30-Jun.-2011 | 50% |
| 2 | 20-Jun.-2012 | 30-Jun.-2012 | 60% |
| 3 | 20-Jun.-2013 | 30-Jun.-2013 | 70% |
| 4 | 20-Jun.-2014 | 30-Jun.-2014 | 80% |
| 5 | 20-Jun.-2015 | 30-Jun.-2015 | 100% |
| 6 | 20-Jun.-2016 | 30-Jun.-2016 | 120% |
| 7 | 20-Jun.-2017 | 30-Jun.-2017 | 140% |
| 8 | 20-Jun.-2018 | 30-Jun.-2018 | 160% |
| 9 | 20-Jun.-2019 | 30-Jun.-2019 | 180% |
| 10 | 20-Jun.-2020 | 30-Jun.-2020 | 200% |

In this table, in addition to being the first interest payment date, 30-Jun.-2010 is the loan drawdown date and the strike date (meaning the performance of the underlying investment strategy becomes ‘live as at the close of that date’).

With regard to the 20 Jun. 2020 date, as it represents a date at the end of the final period, it is not an interest payment date as such, as the investor is required to have pre-paid interest at the start of the year 10 period i.e. on 20-Jun.-2019. Instead, 20 Jun. 2020 is the date when a final coupon may be payable.

### Contingent Coupon Payments

According to an embodiment of the present invention, contingent coupon payments may be payable depending on investment growth over each period, and payments may be capped at, for example, 10% of an initial unit's cost.

Coupon amount may be calculated for year Y, for example, as:

Coupon Amount=Coupon Payout Percentage (Y)*Strategy Value Growth (Y)

where:
Strategy Value Growth (Y)=Max [0, Underlying Investment Strategy Value (Y)−Initial Strategy Value]
Underlying Investment Strategy Value (Y)=closing value of the Underlying Investment Strategy on Coupon Calculation Date (Y)
If the Coupon Amount calculated as set out above exceeds the Maximum Coupon Amount, then Coupon Amount (Y)=Maximum Coupon Amount for that year (Y).

The Coupon Amount may depend on the Coupon Payout Percentage applicable on the Coupon Calculation Date.

In addition, the Coupon Payout Percentage may affect the level of exposure to the Underlying Investment Strategy in the calculation of the Coupon Amount.

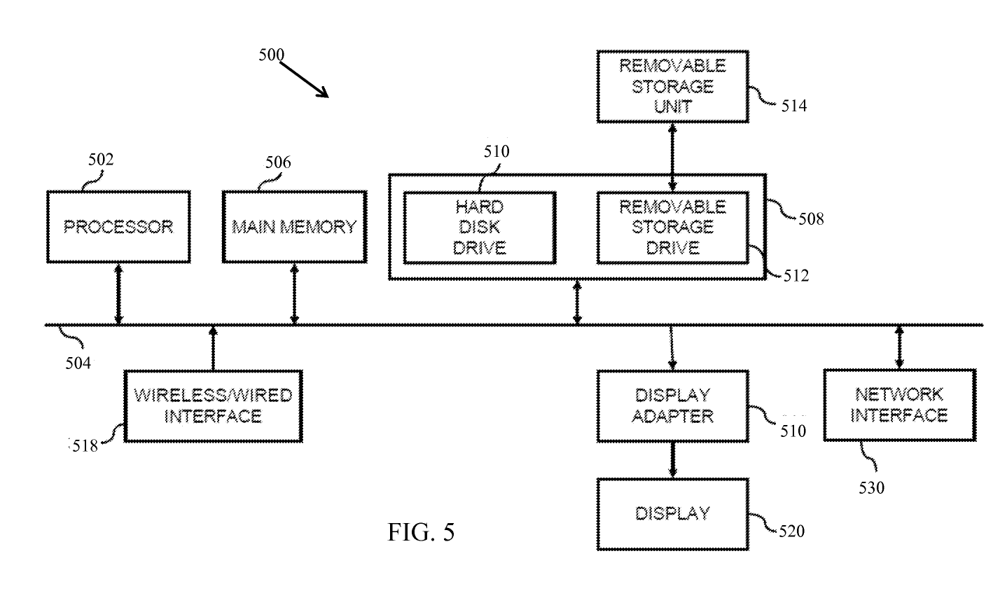

A computer system 500 suitable for operating as an investment system according to an embodiment of the present invention will now be described with reference to the system diagram in FIG. 5. The computer system 500 includes one or more processors 502 providing an execution platform for executing software. Thus, the computer system 500 includes one or more single-core or multi-core processors of any of a number of computer processors, such as processors from Intel, AMD, and Cyrix. As referred herein, a computer processor may be a general-purpose processor, such as a central processing unit (CPU) or any other multi-purpose processor or microprocessor. A computer processor also may be a special-purpose processor, such as a digital signal processor, or another processor dedicated for one or more processing purposes. Commands and data from the processor 502 are communicated over a communication bus 504 or through point-to-point links (not shown) with other components in the computer system 500.

The computer system 500 also includes a main memory 506 where software is resident during runtime, and a secondary memory 508. The secondary memory 508 may also be a computer-readable medium that may be used to store software programs, applications, the investor database, or modules that implement the methods (as described above), or parts thereof. The main memory 506 and secondary memory 508 (and an optional removable storage unit 514) each includes, for example, a hard disk drive and/or a removable storage drive 512 representing a floppy diskette drive, a magnetic tape drive, a compact disk drive, etc., or a non-volatile memory where a copy of the software is stored. In one example, the secondary memory 508 also includes ROM (read only memory), EPROM (erasable, programmable ROM), EEPROM (electrically erasable, programmable ROM), or any other electronic, optical, magnetic, or other storage or transmission device capable of providing a processor or processing unit with computer-readable instructions. The computer system 500 includes a display 520 connected via a display adapter 522, user interfaces comprising one or more input devices 518, such as a keyboard, a mouse, a stylus, and the like. However, the input devices 518 and the display 520 are optional. A network interface 530 is provided for communicating with other computer systems via, for example, the network.

The above embodiments are to be understood as illustrative examples of the invention. Further embodiments of the invention are envisaged. For example, the invention encompasses variants in which one or more of the functions performed by the investment system are performed manually by a person or people instead of by a programmed computer. For example, investment requests might be made by telephone to a trading desk, instead of, or in addition to, via the investment portal, etc. In addition, or alternatively, the loan may be manually arranged in a known way, and/or managed outside of the investment system rather than being a part of the investment system as such. In addition, or alternatively, exit requests may be made manually in some embodiments.

The functions of the investment system may be implemented by a single computer or by plural computers, which may be connected via local or even wide area networks.

It is to be understood that any feature described in relation to any one embodiment may be used alone, or, if the context permits, in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer implemented investment method, comprising:
financing an investor with a limited-recourse loan to make an investment in a security, the investment having an underlying investment strategy, which is to be applied over a plurality of investment periods, and periodic investment exit points;
for each period of the investment, calculating a payment, which is payable by the investor in order to remain invested in the investment;
investing during each period according the underlying investment strategy;
calculating:
a first redemption value if the investor exits at an exit point before the end of a final period, the value at least in part determined by the performance of the investment up to the point of exit; or
a second redemption value if the investor remains invested over all periods, the value at least in part determined by the performance of the investment up to the end of the final period; and
determining a redemption payment to the investor according to the respective redemption value and the loan amount.

2. The method of claim 1, wherein the calculated payment includes at least an interest payment on the loan.

3. The method of claim 1, wherein the liability of the investor to repay the loan is limited by the investment performance.

4. The method of claim 3, wherein the liability of the investor to repay the loan is limited to no more than the respective redemption value.

5. The method of claim 1, wherein the first and/or second redemption value is calculated based at least in part on a function of the investment growth over the respective investment period.

6. The method of claim 5, wherein the function weights the value by increasing or decreasing the value depending on the period for which the investor remains invested in the investment.

7. The method of claim 6, wherein the function weights a value of the investment growth such that a given investment growth has a lower value for a relatively shorter period of investment and a relatively higher value for a relatively longer period of investment.

8. The method of claim 5, wherein the redemption payment associated with the first redemption value is calculated based on the maximum of a pre-agreed absolute minimum return and a function of the actual investment growth over the period invested in minus the loan amount.

9. The method of claim 5, wherein the redemption payment associated with the second redemption value is calculated based on the maximum of a pre-agreed absolute minimum return, a function of the actual investment growth over the period invested in minus the loan amount and a pre-agreed minimum return minus the loan amount.

10. The method of claim 9, wherein the minimum pre-agreed return is zero.

11. The method of claim 1, wherein the investment strategy is coupon-bearing, whereby a coupon may be payable to the investor at the end of each investment period.

12. The method of claim 11, wherein the coupon is a contingent coupon, which has a value of zero or more and is payable depending on investment performance.

13. The method of claim 11, wherein the second redemption value is reduced by a factor determined by a value of any coupons that have been paid.

14. The method of claim 1, wherein each investment period is a year.

15. The method of claim 1, wherein the loan comprises a 100% loan for the investment amount.

16. The method of claim 1, wherein the loan is repayable at par with no penalty fees.

17. The method of claim 1, wherein the investment strategy is a volatility-stabilised investment strategy.

18. An automated investment system, comprising: a processor programmed to perform an underlying investment strategy over a plurality of investment periods, the processor being responsive, with respect to an investment amount of each of a plurality of investors, to make investments according to the underlying investment strategy based on signals indicating a level of investment, market conditions and receipt of a payment from the investor for an investment period.

19. The system of claim 18, wherein the payment from the investor includes at least an interest payment.

20. A computer program product containing thereon computer readable instructions, which, when executed by a programmable processor, performs at least a part of a method comprising:
financing an investor with a limited-recourse loan to make an investment in a security, the investment having an underlying investment strategy, which is to be applied over a plurality of investment periods, and periodic investment exit points;
for each period of the investment, calculating a payment, which is payable by the investor in order to remain invested in the investment;
investing during each period according the underlying investment strategy;
calculating:
a first redemption value if the investor exits at an exit point before the end of a final period, the value at least in part determined by the performance of the investment up to the point of exit; or
a second redemption value if the investor remains invested over all periods the value at least in part determined by the performance of the investment up to the end of the final period; and
determining a redemption payment to the investor according to the respective redemption value and the loan amount.
